(19) United States
(12) Patent Application Publication
(10) Pub. No.: US 2024/0256488 A1
(43) Pub. Date: Aug. 1, 2024

(54) PREEMPTIVE PROCESSING TO AVOID DATA ROT

(71) Applicant: INTERNATIONAL BUSINESS MACHINES CORPORATION, Armonk, NY (US)

(72) Inventors: Dong CHEN, Beijing (CN); Su LIU, Austin, TX (US); Syed I. HAIDERZAIDI, Round Rock, TX (US); Yang LIANG, Beijing (CN)

(21) Appl. No.: 18/161,204

(22) Filed: Jan. 30, 2023

(51) Int. Cl. G06F 16/174; G06F 9/445

(52) U.S. Cl. CPC G06F 16/174; G06F 9/44505

(57) ABSTRACT

Provided are techniques for intelligent preemptive processing to avoid data from becoming Redundant, Obsolete or Trivial (ROT). An application configuration is monitored to generate application configuration data. Application settings are reconfigured based on the application configuration data and based on a risk data list, where the risk data list identifies one or more data files. A data file of the data files in an existing data format is preemptively converted to a new data format based on the reconfigured application settings. An attempt is made to verify the conversion by using the reconfigured application settings. In response to determining that the conversion succeeded and that a request is received from a new application to open the data file, the data file having the new data format is opened. In response to determining that the conversion failed, an error message is sent to request update of server data.

### BACKGROUND

Embodiments of the invention relate to preemptive processing to avoid data that is Redundant, Obsolete or Trivial (ROT). In particular, embodiments of the invention relate to intelligent preemptive processing to avoid ROT data being stored.

When an organization is dealing with a large amount of ROT data, the productivity and general output of that organization suffers.

Data ROT may be described as the gradual corruption of computer data in a data file due to an accumulation of non-critical failures in a data storage device, which leads to storage of the ROT data.

There are different types of data ROT. For example, some causes of data ROT in personal devices and cloud storage are 1) incompatible applications settings, and 2) correlated data formats created by heterogeneous applications and configurations in different environments. Without the correct application and configuration settings, the incompatible data cannot be opened and read.

For example, a first email application may create and save a file, then a second email application may want to open and render that file. However, the second email application may not be able to open the file due to incompatible application and/or configuration settings.

Data may be stored (e.g., as web content, etc.) in heterogeneous data formats (e.g., audio format, video format, image format, Hypertext Markup Language (HTML) format, Portable Document Format (PDF), text format, spreadsheet format, presentation format, etc.). In conventional systems, there may be not by an efficient way to retrieve and use them to access a file, even if the file is digitized data.

Users may not be able to open, retrieve, access, and process an attached file, which was received decades ago, due to lacking the licensed tool or application used for that file.

Conventional systems may use Electronic Data Interchange (EDI) modules to address some of these problems, but, the manual operation of these EDI modules it costly, time consuming, and prone to error.

### SUMMARY

In accordance with certain embodiments, a computer-implemented method that performs operations is provided for preemptive processing to avoid data ROT. In such embodiments, an application configuration is monitored to generate application configuration data. Application settings are reconfigured based on the application configuration data and based on a risk data list, where the risk data list identifies one or more data files that are at risk of becoming at least one of redundant, obsolete, and trivial. A data file of the data files in an existing data format is preemptively converted to a new data format based on the reconfigured application settings. An attempt is made to verify the conversion by using the reconfigured application settings. In response to determining that the conversion succeeded, receiving a request from a new application to open the data file created in the existing data format and opening the data file having the new data format. In response to determining that the conversion failed, an error message is sent to request update of server data.

In accordance with other embodiments, a computer program product is provided for preemptive processing to avoid data ROT. The computer program product comprises a computer readable storage medium having program code embodied therewith, the program code executable by at least one processor to perform operations. In such embodiments, an application configuration is monitored to generate application configuration data. Application settings are reconfigured based on the application configuration data and based on a risk data list, where the risk data list identifies one or more data files that are at risk of becoming at least one of redundant, obsolete, and trivial. A data file of the data files in an existing data format is preemptively converted to a new data format based on the reconfigured application settings. An attempt is made to verify the conversion by using the reconfigured application settings. In response to determining that the conversion succeeded, receiving a request from a new application to open the data file created in the existing data format and opening the data file having the new data format. In response to determining that the conversion failed, an error message is sent to request update of server data.

In accordance with yet other embodiments, a computer system is provided for preemptive processing to avoid data ROT. The computer system comprises one or more processors, one or more computer-readable memories and one or more computer-readable, tangible storage devices; and program instructions, stored on at least one of the one or more computer-readable, tangible storage devices for execution by at least one of the one or more processors via at least one of the one or more memories, to perform operations. In such embodiments, an application configuration is monitored to generate application configuration data. Application settings are reconfigured based on the application configuration data and based on a risk data list, where risk data list identifies one or more data files that are at risk of becoming at least one of redundant, obsolete, and trivial. A data file of the data files in an existing data format is preemptively converted to a new data format based on the reconfigured application settings. An attempt is made to verify the conversion by using the reconfigured application settings. In response to determining that the conversion succeeded, receiving a request from a new application to open the data file created in the existing data format and opening the data file having the new data format. In response to determining that the conversion failed, an error message is sent to request update of server data.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing environment in accordance with certain embodiments.

FIG. 2 illustrates an example of an incompatible configuration problem in accordance with certain embodiments.

FIG. 3 illustrates an example of an incompatible application problem in accordance with certain embodiments.

FIG. 4 illustrates components of FIG. 1 and how they are related in accordance with certain embodiments.

FIGS. 5A and 5B illustrates how the components of the server preemptive data processor and the client preemptive data processor work together in accordance with certain embodiments.

FIG. 6 illustrates, in a flowchart, operations performed by the server preemptive data processor in accordance with certain embodiments.

FIG. 7 illustrates, in a flowchart, operations performed by the client preemptive data processor in accordance with certain embodiments.

FIG. 8 illustrates an example application and data format structure in accordance with certain embodiments.

FIGS. 9A and 9B illustrates an example in which a default application changes in accordance with certain embodiments.

FIG. 10 illustrates, in a flowchart, operations for preemptive processing to avoid data ROT in accordance with certain embodiments.

FIG. 11 illustrates a server computing environment in accordance with certain embodiments.

FIG. 12 illustrates a client computing environment in accordance with certain embodiments

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

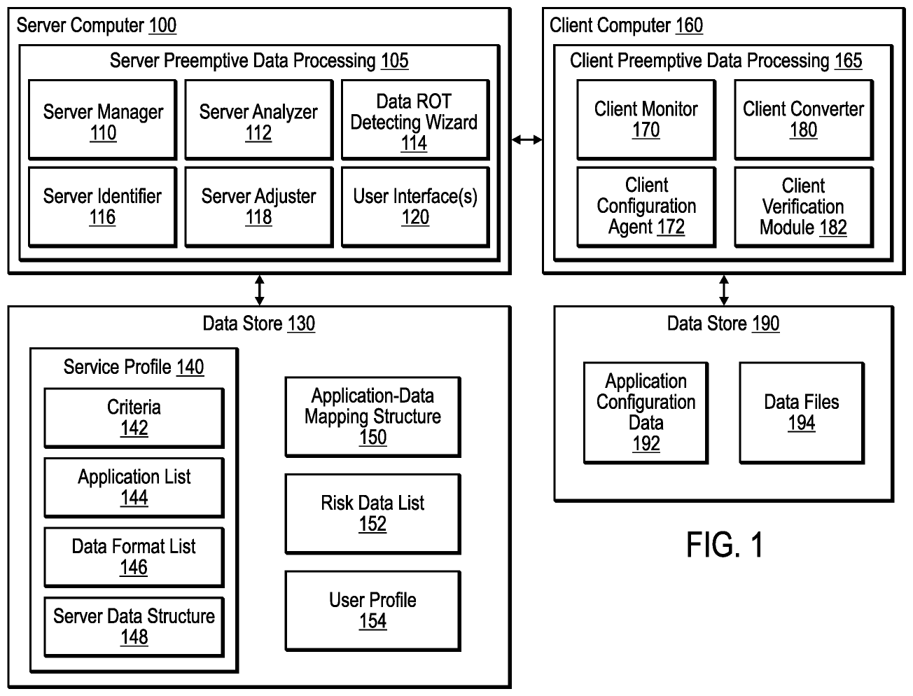

FIG. 1 illustrates, in a block diagram, a computing environment in accordance with certain embodiments. A server computer 100 is connected to a client computer 160. The server computer is connected to a data store 130. The client computer 160 is connected to a data store 190.

The server computer 100 includes a server preemptive data processor 105. The server preemptive data processor 105 includes a server manager 110, a server analyzer 112, a data ROT detecting wizard 114, a server identifier 116, a server adjuster 118, and one or more user interfaces 120.

The data store 130 includes a service profile 140, an application-data mapping structure 150 (e.g., a table, a risk data list 152, and a user profile 154.

With embodiments, the service profile 140 may be described as a universal profile for a service for intelligent preemptive processing to avoid data ROT that includes criteria 142, an application list 144, a data format list 146, and a server data structure 148. With embodiments, a system administrator may configure, modify, and update the criteria 142, the application list 144, the data format list 146, and the server data structure 148 through the user interface 120 provided by the server manager 110.

With embodiments, the user profile is a personal, customizable profile for supporting any personalized service. For example, a user may enable/disable the service for intelligent preemptive processing to avoid data ROT, may include applications and data formats to be monitored and updated, etc.

Thus, the service profile 140 includes universal settings, while the user profile 154 has personal settings.

With embodiments, the criteria 142 may include rules. For example, a company may send an alert that a first email application will be replaced and removed (from the email server and from the client) in about 6 months. The criteria 142 may include a rule to monitor such alerts: If APP-X (in cloud, local computer, edge computer, etc.) is to be sunset, is to be uninstalled, is to be unsupported, is to be removed, is awaiting a payment, a license is ending, updates are on the scheduled system managed events, notifications are available, Information Technology (IT) channel, etc., then the embodiments convert the related data format to a another data format that so that the converted data file 194 may be opened/accessed/processed by another App-Y. Embodiments may also associate the data format of the sunset application APP-X to a compatible application, such as APP-Y.

With embodiments, the application-data mapping structure 150 stores metadata and data formats associated with each application.

The client computer 160 includes a client preemptive data processor 165. The client preemptive data processor 165 includes a client monitor 170, a client configuration agent 172, a client converter 180, and a client verification module 182. The data store 190 includes application configuration data 192 and data files 194.

With embodiments, a data file 194 may be any type of data (e.g., web content, a text file, a spreadsheet file, a presentation file, an email, etc.). With embodiments, a data file 194 may be said to contain the data.

With embodiments, data formats of data files 194 include: compressed formats, encoded formats, application readable formats, and data types (e.g., integer. float, character, etc.), etc. In addition, the data formats of data files 194 may be: audio format, video format, image format, HTML format, Portable Document Format (PDF), text format, spreadsheet format, presentation format, email format, etc.).

The server preemptive data processor 105 and the client preemptive data processor 165 preemptively avoid data ROT with data ROT prediction, application configuration, and data format conversion.

The server preemptive data processor 105 and the client preemptive data processor 165 address incompatible configuration problems and incompatible application problems.

The server preemptive data processor 105 and the client preemptive data processor 165 define an intelligent preemptive technique for preventing data ROT in a data platform. The server preemptive data processor 105 and the client preemptive data processor 165 provide a framework to prevent data ROT.

With embodiments, the server manager 110 uses the service profile 140, the criteria 142, the application list 144, the data format list 146, and the application-data mapping structure 150 to define a user interface 120 for operations for preventing data ROT. In certain embodiments, the user interface 120 provides (e.g., displays) the criteria 142, the application list 144, the data format list 146, and the application-data mapping structure 150. Then, the user interface 120 allows operations for updating the criteria 142, the application list 144, the data format list 146, and the application-data mapping structure 150. In certain embodiments, the server manager 110 provides the user interface 120 to allow creation of rules (e.g., if a file is of data format abc, use application 123 to open the file; if application 789 that created a file is no longer available, covert that file to data format xyz; etc.

With embodiments, the application to data format mapping structure 150 maps the application name to the associated data format (e.g., app-name: associated data format). For instance, a text application may have a data format of document with extension .mno, while a presentation application may have a data format of presentation with extension .xyz.

Also, some operating systems provide a command that provides the application associated with a provided data format. For example, the command C:\User\PersonA>Assoc.abc may output a first application for the data format of .abc. As another example, the command C:\User\PersonA>Assoc.xyz may output a second application for the data format of .xyz. As yet another example, the command C:\User\PersonA>Assoc.123 may indicate that an application association has not been found for the extension .123.

With embodiments, a system administrator may modify, using the user interface 120, the following: the criteria 142 (e.g., when and how to preemptively process data to avoid data ROT and for which data formats and applications, the application list 144 (e.g., the applications that are to be monitored), the data format list 146 (e.g., the data formats that are to be monitored and converted), and the server data structure 148 (e.g., which indicates attributes that are to be tracked).

The server computer 100 provides a new application and data format structure 148. In certain embodiments, the application and data format structure 148 is a table with columns for the following data: a new application identifier (NewApplicationID) that indicates a new application added to the application list 144, a new mapped data format identifier (NewMappedDataFormatID) that indicates a new data format added to the data format list 146, an existing application identifier (ExistingApplicationID) that indicates an existing (e.g., previously used) application, an existing mapped data format identifier ExistingMappedDataFormatID that indicates an existing (e.g., previously used) data format, a storage identifier (StorageID) that indicates storage where a data file is stored, a new data path (NewDataPath) that indicates a data path in the storage for a new data file, a new data file identifier (NewDataFileID) that indicates a data file identifier for the new data, an existing data path (ExistingDataPath) that indicates an existing data path to an existing data file, an existing data file identifier (ExistingDataFileID) that indicates a data file identifier for the existing data file. Identifier may be referred to as ID.

For example, an existing email application (ExistingApplicationID) using an existing data format (ExistingMappedDataFormatID) may be replaced by a new email application (NewApplication ID) using a new data format (NewMappedDataFormatID), then a data file (ExistingDataFileID) created by the existing email application and stored at an existing data path (ExistingDataPath) may be converted to a new data file (NewDataFileID) that is stored in the storage (StorageID) at a new data path (NewDataPath) and is accessible by the new email application.

With embodiments, the client monitor 170 is a monitoring application that monitors the application configuration and generates application configuration data 192 based on changes. The application configuration data 192 includes installation of new applications, uninstallation (deletion) of existing applications, updates to existing applications, default applications, default data formats, etc. That is, an application may be configured by: installation of new applications, uninstallation (deletion) of existing applications, updates to existing applications, default applications, default data formats, etc. With embodiments, the client monitor 170 generates the application configuration data 192 based on changes from a prior application configuration (e.g., that has been stored) and the current application configuration.

The server analyzer 112 analyzes any changes to the existing application configuration (e.g., such as changes of default applications and default data formats to determine whether these have changed and new default applications and default data formats should be used), which may result in some data files being preemptively converted to the new data format. With embodiments, the server analyzer 112 analyzes the application configuration data 192 to identify the changes.

The data ROT detecting wizard 114 detects and predicts data ROT risk according to existing data formats and configurations changes in the data platform. The data ROT detecting wizard 114 predicts data ROT accessing rules that indicate which application opens which data format. For example, if a particulate application is uninstalled, the data ROT detecting wizard 114 sends a prediction that files created by the uninstalled application are to be converted and/or are to be opened with a different application.

The server identifier 116 identifies particular data files in first data formats that are to be converted to second data formats using the risk data list 152. With embodiments, the risk data is a list of data formats and data files having those data formats to convert. For example, if a first email application is going to be removed, the data format used by the first email application is placed on the risk data list 152. Then, data files with the data format on the risk data list 152 are converted by the client converter 180.

The client configuration agent 172 reconfigures application settings. For example, the default application to use for a particular data format may be updated. As another, example, the client configuration agent 172 may create a rule of: Open Data-2 with Application-2: Ftype em1=C:\Program Files (x86)\EMAILAPP.exe %1.

The client converter 180 converts data files with existing data formats to new data formats according to the new configured application settings. The following is an example configuration setting for converting data formats: Convert (NewDataPath, NewDataFileID, ExistingDataPath, ExistingDataFileID).

The client verification module 182 verifies the converted data file by using the new configured application settings.

The server adjuster 118 adjusts the criteria 142, the application list 144, the data format list 146, the user profile 154, the application-data mapping structure 150, and the correlated application configuration (e.g., which maps a particular application to a particular data format) according to the verification results. For example, if the verification results indicate that converted data was not accurate or could not be opened, the server adjuster 118 makes adjustments, and then the client converter 180 tries to convert the data file again.

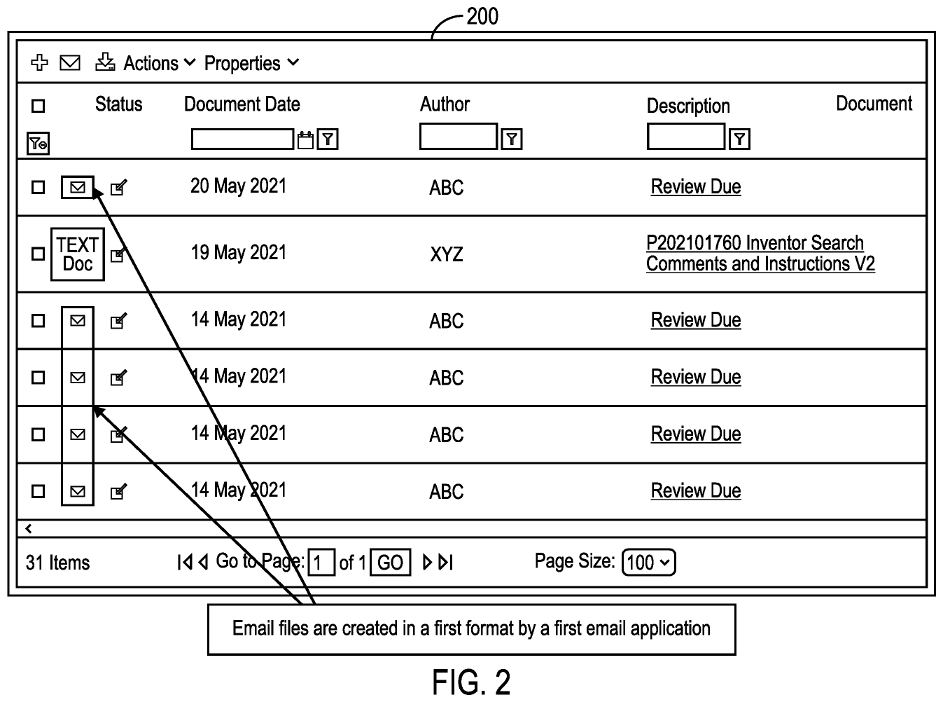

FIG. 2 illustrates an example of an incompatible configuration problem in accordance with certain embodiments. In FIG. 2, a user interface 200 lists email files. In this example, the email files were created with a first application in a first data format. However, a second application that creates/opens email files in a second data format is used to open the email files in the first data format, but the second application is not able to open the email files in the first data format. This example of using an incorrect application is an incompatible configuration problem.

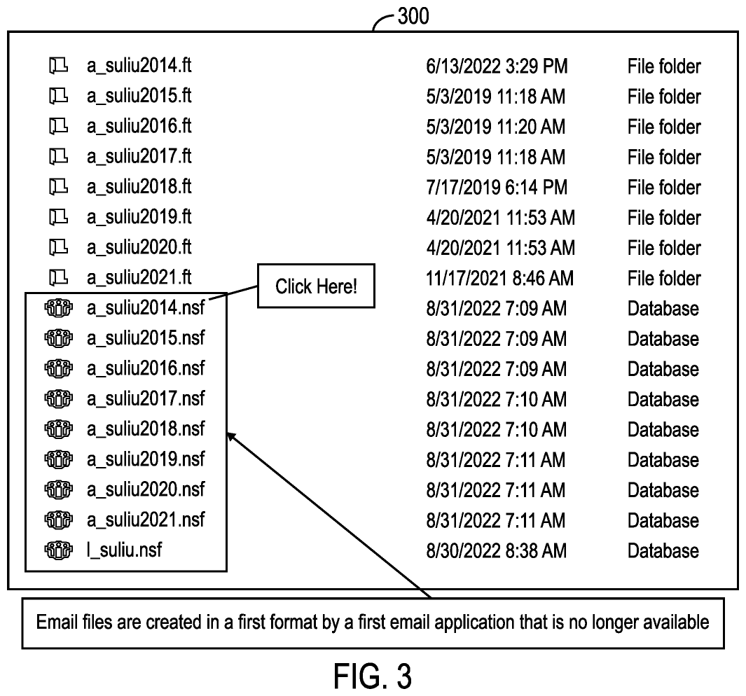

FIG. 3 illustrates an example of an incompatible application problem in accordance with certain embodiments. In FIG. 3, a user interface 300 lists email files. In this example, the email files are created in a first data format by a first email application that is no longer available. In this example of an incompatible application problem, the specific application that would be able to open a file is not available. Another example of the incompatible application problem is trying to open an attachment to an older email when the application that would open that email is no longer available.

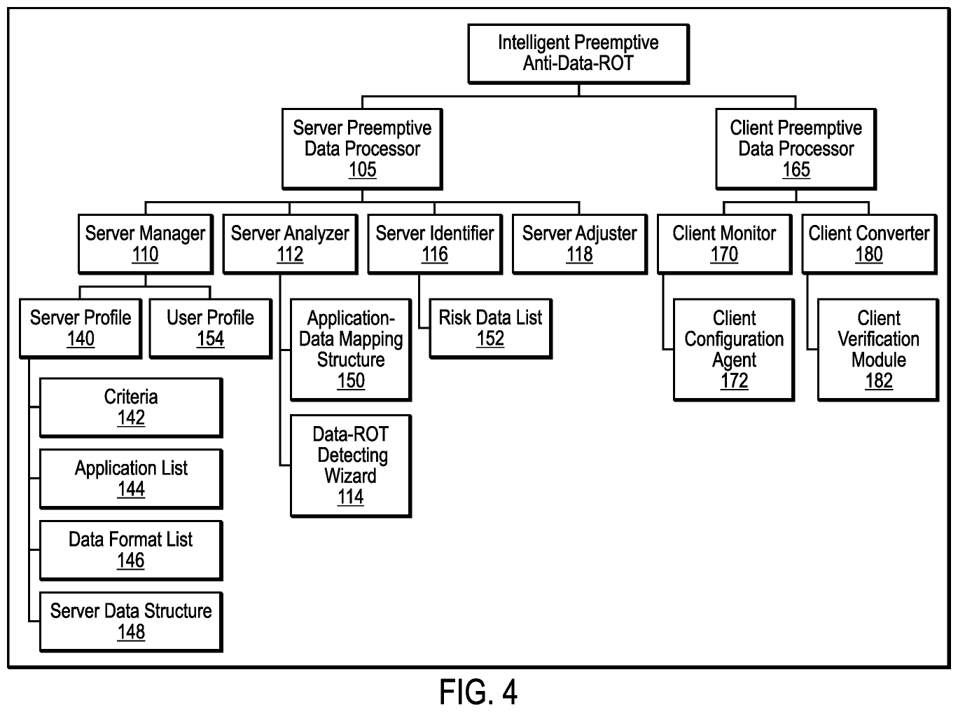

FIG. 4 illustrates components of FIG. 1 and how they are related in accordance with certain embodiments. In FIG. 4, the server preemptive data processor 105 executes the server manager 110, the server analyzer 112, the server identifier 116, and the server adjuster 118. The server manager 110 uses the service profile 140, the criteria 142, the application list 144, the data format list 146, and the application-data mapping structure 150 to update a user interface 120. The server analyzer 112 uses the application-data mapping structure 150 and works with (or initiates) the data ROT detecting wizard 114. The server identifier 116 uses the risk data list 152. The client preemptive data processor 165 executes the client monitor 170 and the client converter 180. The client monitor 170 works with (or initiates) the client configuration agent 172. The client converter 180 works with (or initiates) the client verification module 182.

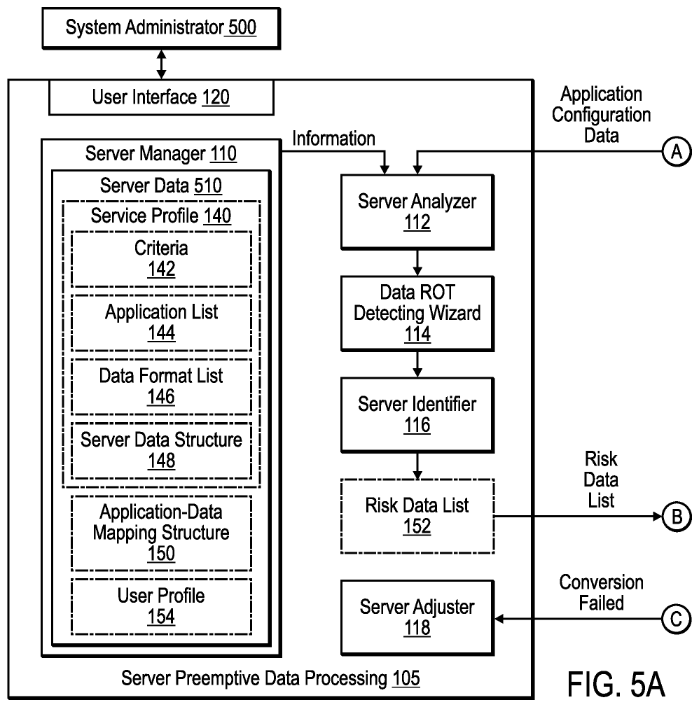

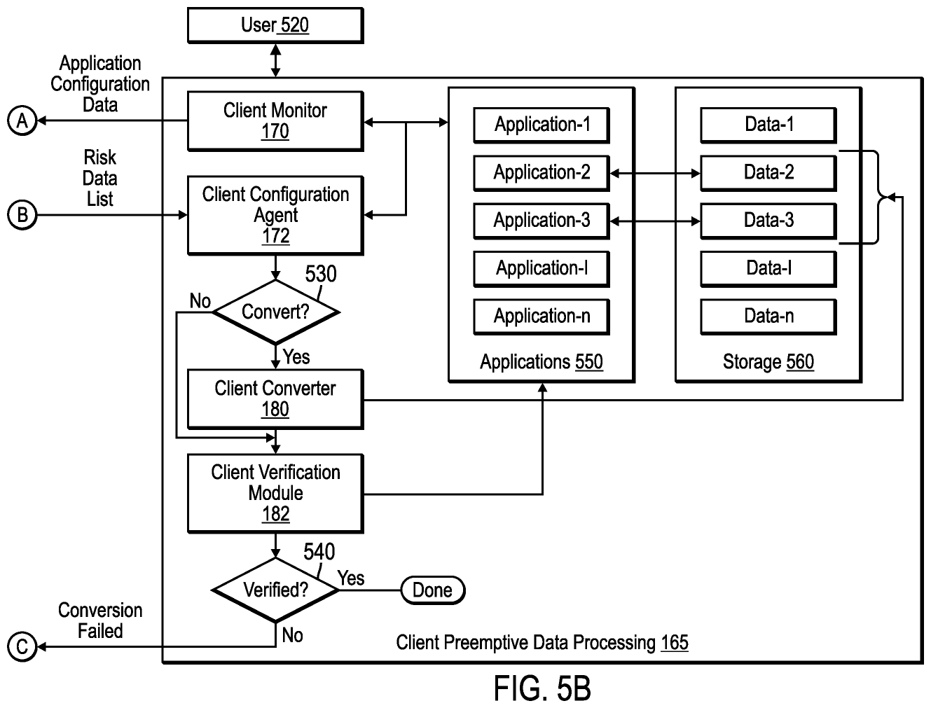

FIGS. 5A and 5B illustrates how the components of the server preemptive data processor 105 and the client preemptive data processor 165 work together in accordance with certain embodiments. A system administrator 500 may interact with the server preemptive data processor 105. A user 520 may interact with the client preemptive data processor 165.

The client monitor 170 generates application configuration data 192 from monitoring the applications 550. The applications 550 create, update, and delete data files in storage 560. The client monitor 170 sends the application configuration data 192 to the client configuration agent 182 and to the server analyzer 112.

The client configuration agent receives the risk data list 152, receives the application configuration data 192, and determines whether any data files should be preemptively converted (block 530). If any data files are to be converted, the client converter 180 performs the conversion, otherwise, processing continues to the client verification module 182. The client verification module 182 verifies whether the data files were converted properly (block 540). For example, the client verification module 182 may try to open a converted data file with an appropriate application identified in the application configuration data 192. If the data file successfully opens, then the conversion and verification succeeded, otherwise, the conversion and verification failed.

If the client verification module 182 determines that the conversion is correct, then processing is done, otherwise, an indication that conversion failed is sent to the server adjuster 118. With embodiments, an error message is sent to the server adjuster 118. For example, the error message may indicated that: a file with data format .abc (created by a first email application) cannot be opened by a second email application. As another example, the error message may indicate that a file with data format .xyz cannot be opened by the default email application. As a further example, the error message may indicate that an attached *.st file in an email cannot be opened after system update.

The server adjuster 118 adjusts one or more of: the service profile 140, the criteria 142, the application list 144, the data format list 146, the application and data format structure 148, and the application-data mapping structure 150. Examples of adjustments include: Adjustment may include: add a new data format conversion module for converting unconvertable data format-A to data format-B, update/modify the association relation between an application and a data format, convert default encodings, etc.

The server manager 110 sends information (e.g., an error log) to the server analyzer 112. With embodiments, the error log may include an application name and failed information such as: cannot find a correct conversion module to convert a first data format to a second data format for the application, failed to convert a convert a first data format to a second data format for the application due to inefficient disk space, cannot App-Y to access a data file with the second data format, etc.

With embodiments, the combination of the service profile 140 (which includes the criteria 142, the application list 144, the data format list 146, and the application and data format structure 148), the application-data mapping structure 150, and the user profile 154 may be described as server data 510.

The server analyzer 112 analyzes any changes of default applications and default data formats and sends this to the data ROT detecting wizard 114. The data ROT detecting wizard 114 detects possible data ROT based on changes to the existing applications, existing data formats, new applications, and new data formats.

The data ROT detecting wizard 114 sends data to the server identifier 116. In certain embodiments, the data sent may indicate: that a data file with a certain data format will not be accessible after Application-X is deinstalled or the license is ended, that a data file with a certain data format should be associated with a newly installed App-Y as the default application, etc.

The server identifier 116 determines what data files should be converted from an data existing (first) data format to a new (second) data format and updates the risk data list 152 with this information. The server identifier 116 sends the risk data list 152 to the client configuration agent 172.

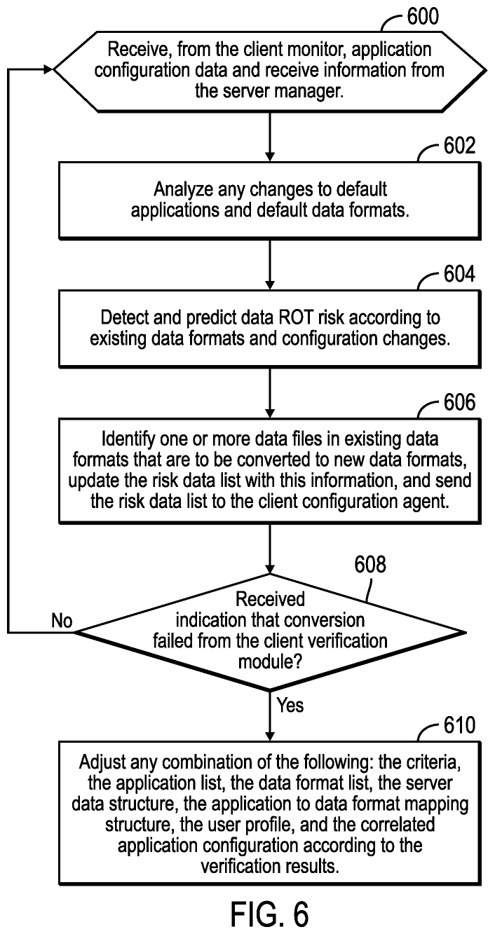

FIG. 6 illustrates, in a flowchart, operations performed by the server preemptive data processor 105 in accordance with certain embodiments. Control begins at block 600 with the server analyzer 112 receiving, from the client monitor 170, application configuration data 192 and receiving information from the server manager 110. In block 602, the server analyzer 112 analyzes any changes to default applications and default data formats. In block 604, the data ROT detecting wizard 114 detects and predicts data ROT risk according to existing data formats and configuration changes. In block 606, the server identifier 116 identifies one or more data files in existing data formats that are to be converted to new data formats, updates the risk data list 152 with this information, and sends the risk data list 152 to the client configuration agent 172. In block 608, the server adjuster 118 determines whether an indication that conversion failed has been received from the client verification module 182. If so, processing continues to block 610, otherwise, processing loops back to block 600. In block 610, the server adjuster 118 adjusts one or more of the following: the criteria 142, the application list 144, the data format list 146, the server data structure 148, the application to data format mapping structure 150, the user profile 154, and the correlated application configuration according to the verification results. Once the server data is updated, a new risk data list is generated and sent to the client configuration agent 172.

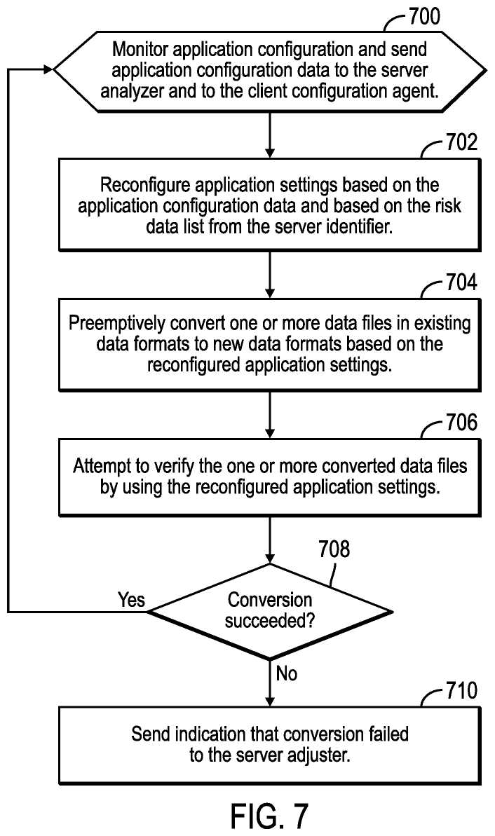

FIG. 7 illustrates, in a flowchart, operations performed by the client preemptive data processor 165 in accordance with certain embodiments. Control begins at block 700 with the client monitor 170 monitors application configuration and sends application configuration data to the server analyzer 112 and to the client configuration agent 172. In block 702, the client configuration agent 172 reconfigures application settings based on the application configuration data 192 and based on the risk data list 152 from the server identifier 116. For example, reconfiguring an application setting may be updating which data format is associated with a particular application. In block 704, the client converter 180 preemptively converts one or more data files in existing data formats to new data formats based on the reconfigured application settings. In block 706, the client verification module 182 attempts to verify the one or more converted data files by using the reconfigured application settings. In block 708, the client verification module 182 determines whether the conversion succeeded. If so, processing loops back to block 700, otherwise, processing continues to block 710. In block 710, the client verification module 182 sends an indication that conversion failed to the server adjuster 112. In response to the indication that conversion failed, the server adjuster 112 updates the server data, generates a new risk data list, and sends the new risk data list to the client configuration agent 172.

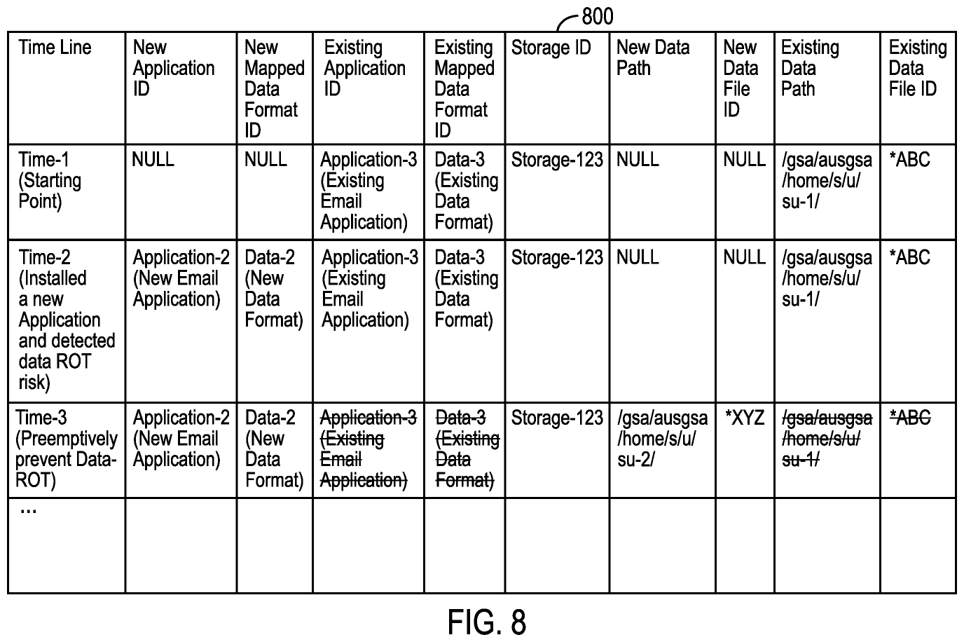

FIG. 8 illustrates an example application and data format structure 800 in accordance with certain embodiments. At Time-1, there is data for an existing application and the data format used by that existing, older application. At Time-2, data is added for a new application and the data format used by that new application. At Time-3, data is removed for the existing application and the data format used by that existing application. With embodiments, not all fields contain data at any given time.

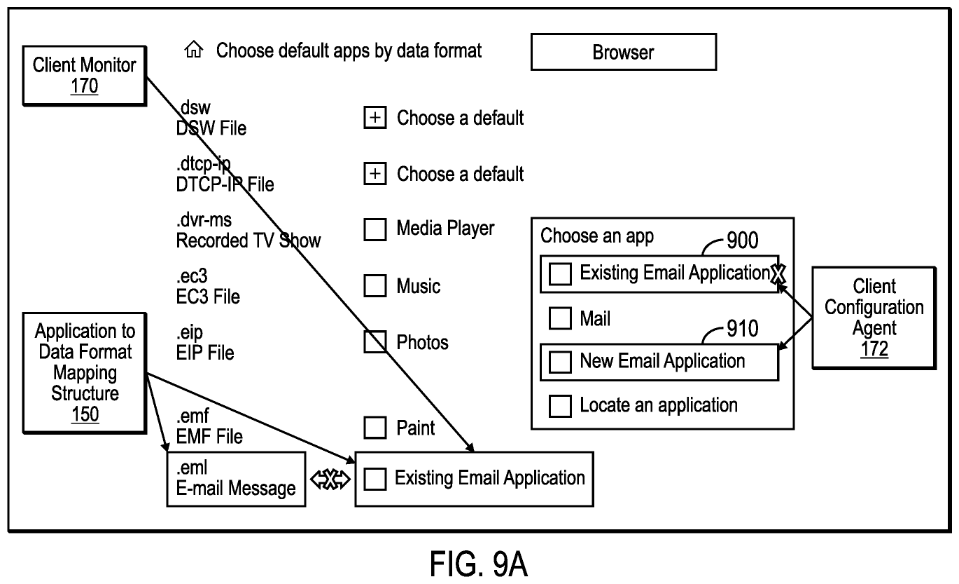

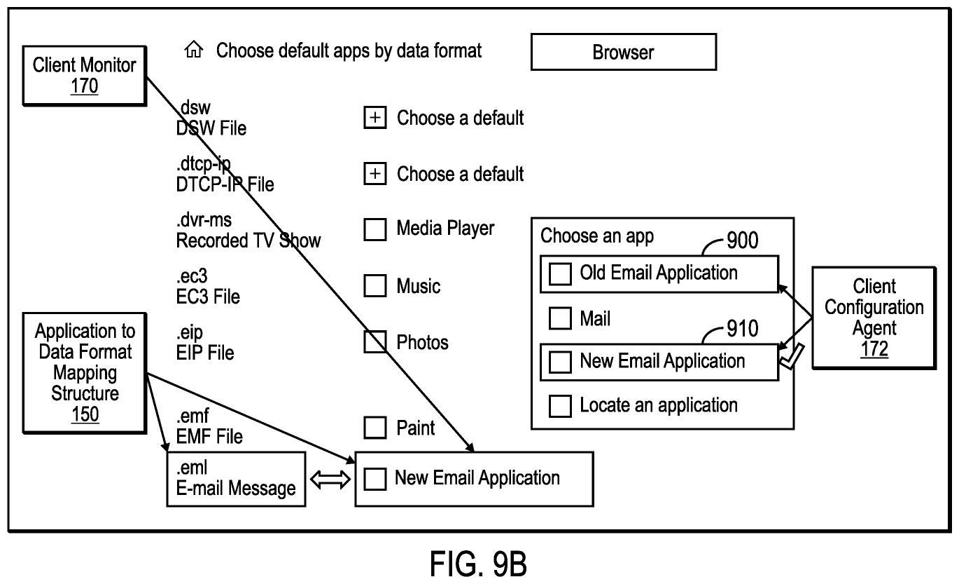

FIGS. 9A and 9B illustrates an example in which a default application changes in accordance with certain embodiments. In response to this change in default application (i.e., an application configuration change), the client monitor 170 generates application configuration data.

In particular, the client monitor 170 determines that an existing, older email application 900 is being removed and replaced with a new email application 910. The client configuration agent 172 reconfigures the application settings based on the application configuration data (i.e., changes configuration settings) so that the new email application 120 becomes the default email application. The client configuration agent 172 updates the application-data mapping structure 150 to indicate that the existing email application 900 is no longer mapping to the data format of .eml and that the new email application 910 maps to the data format of .eml. In certain embodiments, this type of change also triggers the client converter 180 to convert files in the existing data format into a new data format to be accessible by the new email application.

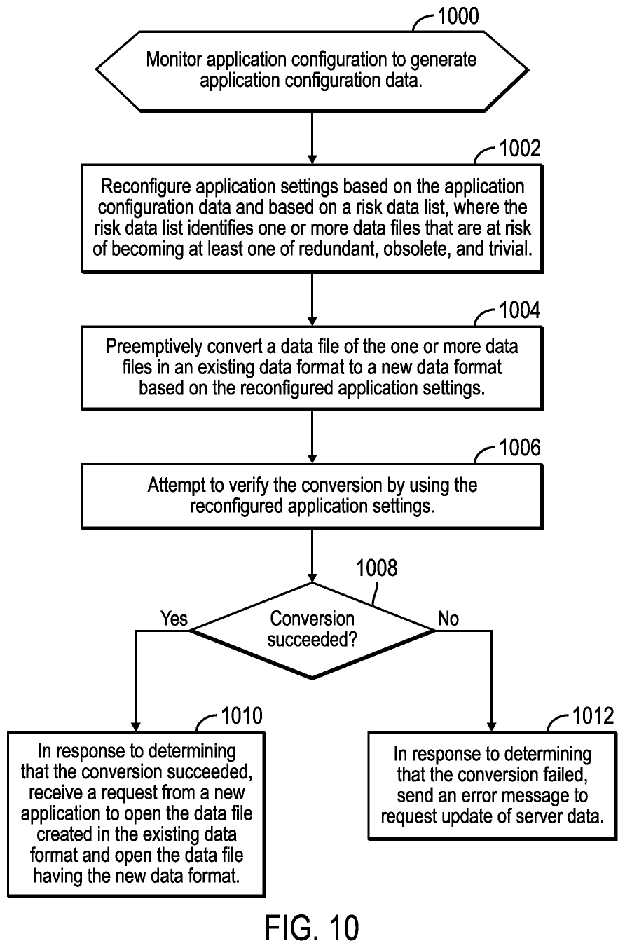

FIG. 10 illustrates, in a flowchart, operations for preemptive processing to avoid data ROT in accordance with certain embodiments. Control begins at block 1000 with the client preemptive data processor 165 monitoring application configuration to generate application configuration data. In block 1002, the client preemptive data processor 165 reconfigures application settings based on the application configuration data and based on a risk data list, where the risk data list identifies one or more data files that are at risk of becoming at least one of redundant, obsolete, and trivial. In block 1004, the client preemptive data processor 165 preemptively converts a data file of the one or more data files in an existing data format to a new data format based on the reconfigured application settings. In block 1006, the client preemptive data processor 165 attempts to verify the conversion by using the reconfigured application settings. In block 1008, the client preemptive data processor 165 determines whether the conversion succeeded. If so, processing continues to block 1010, otherwise, processing continues block 1012.

In block 1010, in response to determining that the conversion succeeded, the client preemptive data processor 165 receives a request from a new application to open the data file created in the existing data format and opens the data file having the new data format.

In block 1012, in response to determining that the conversion failed, the client preemptive data processor 165 sends an error message to request update of the server data. With embodiments, updating of the server data includes updating one or more of: following: the criteria 142, the application list 144, the data format list 146, the server data structure 148, the application to data format mapping structure 150, and the user profile 154.

The server preemptive data processor 105 and the client preemptive data processor 165 minimize the impact of ROT data with proper planning and solutions put in place. The server preemptive data processor 105 and the client preemptive data processor 165 preemptively prevent data ROT in a Human-Computer (HC) environment. The server preemptive data processor 105 and the client preemptive data processor 165 intelligently normalize heterogeneous data formats and configurations according to the appropriate installation history and updating of records. The server preemptive data processor 105 and the client preemptive data processor 165 provide a microservice for supporting intelligent preemptive processing to avoid data ROT in personal storage and cloud storage.

With embodiments, functions of the server preemptive data processor 105 and the client preemptive data processor 165 may be performed at one computing device. With embodiments, the intelligent preemptive processing to avoid data ROT may be provided as: 1) a server-client service (microservice), via a client application/plugin with an API connecting to the server computer 100; or 2) the functionality of the intelligent preemptive processing to avoid data ROT is a single application installed at one computing device (e.g., the client computer 160).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

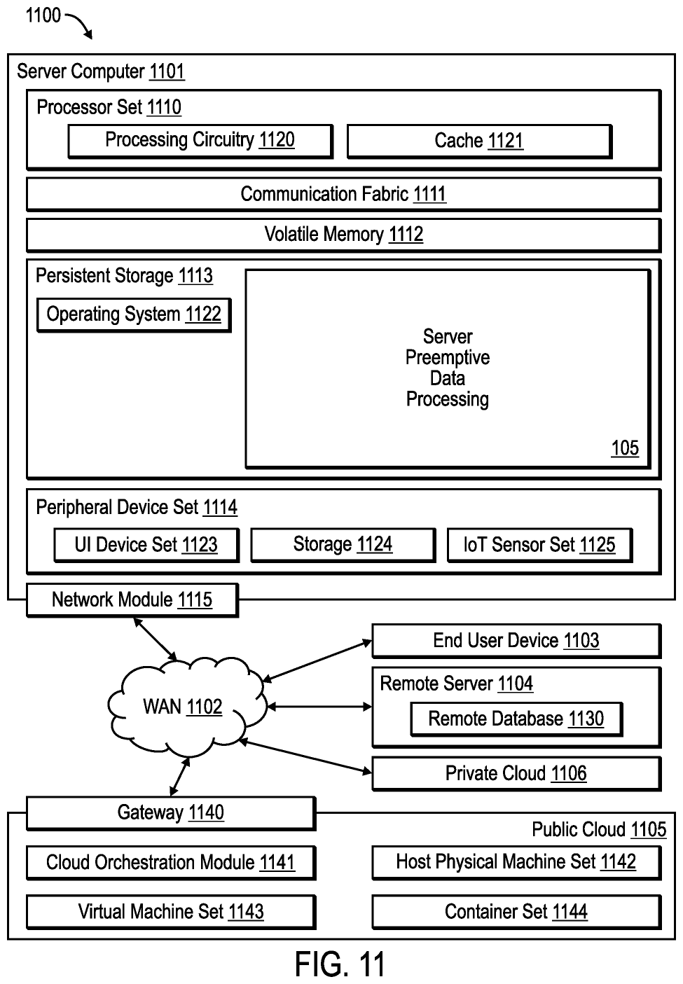

FIG. 11 illustrates a server computing environment 1100 in accordance with certain embodiments. Computing environment 1100 contains an example of an environment for the execution of at least some of the computer code involved in performing the inventive methods, such as a server preemptive data processor 105. In addition to block 105, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 105, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 105 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in block 105 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

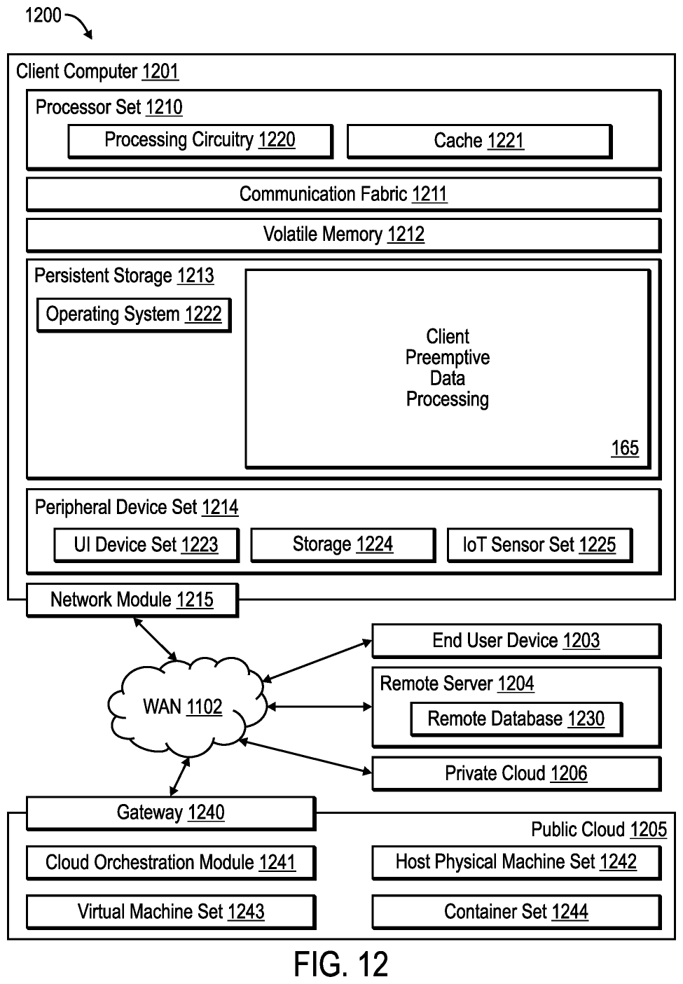

FIG. 12 illustrates a server computing environment 1200 in accordance with certain embodiments. Computing environment 1200 contains an example of an environment for the execution of at least some of the computer code involved in performing the inventive methods, such as a client preemptive data processor 165. In addition to block 165, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 165, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 165 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may 1213 may be a read only memory (ROM), but typically at least a portion of the persistent storage allows writing of data, deletion of data and re-writing of data. Some familiar forms of persistent storage include magnetic disks and solid state storage devices. Operating system 1222 may take several forms, such as various known proprietary operating systems or open source Portable Operating System Interface-type operating systems that employ a kernel. The code included in block 165 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

What is claimed is:

1. A computer-implemented method, comprising operations for:
monitoring application configuration to generate application configuration data;
reconfiguring application settings based on the application configuration data and based on a risk data list, wherein the risk data list identifies one or more data files that are at risk of becoming at least one of redundant, obsolete, and trivial;
preemptively converting a data file of the data files in an existing data format to a new data format based on the reconfigured application settings;
attempting to verify the conversion by using the reconfigured application settings;
in response to determining that the conversion succeeded,
receiving a request from a new application to open the data file created in the existing data format; and
opening the data file having the new data format; and
in response to determining that the conversion failed, sending an error message to request update of server data.

2. The computer-implemented method of claim 1, wherein reconfiguring the application settings comprises creating a mapping between the new application and the existing data format.

3. The computer-implemented method of claim 1, wherein the server data comprises criteria, an application list, a data format list, an application and data format structure, an application to data format mapping structure, and a user profile.

4. The computer-implemented method of claim 1, wherein the application configuration data indicates that a default application has changed.

5. The computer-implemented method of claim 1, wherein the application configuration data indicates that a default data format has changed.

6. The computer-implemented method of claim 1, further comprising:
updating an application and data format structure in accordance with the new application associated with the new data format being added.

7. The computer-implemented method of claim 1, wherein the server data is updated and a new risk data list is generated.

8. A computer program product, the computer program product comprising a computer readable storage medium having program code embodied therewith, the program code executable by at least one processor to perform operations for:
monitoring application configuration to generate application configuration data;
reconfiguring application settings based on the application configuration data and based on a risk data list, wherein the risk data list identifies one or more data files that are at risk of becoming at least one of redundant, obsolete, and trivial;
preemptively converting a data file of the data files in an existing data format to a new data format based on the reconfigured application settings;
attempting to verify the conversion by using the reconfigured application settings;
in response to determining that the conversion succeeded,
receiving a request from a new application to open the data file created in the existing data format; and
opening the data file having the new data format; and
in response to determining that the conversion failed, sending an error message to request update of server data.

9. The computer program product of claim 8, wherein reconfiguring the application settings comprises creating a mapping between the new application and the existing data format.

10. The computer program product of claim 8, wherein the server data comprises criteria, an application list, a data format list, an application and data format structure, an application to data format mapping structure, and a user profile.

11. The computer program product of claim 8, wherein the application configuration data indicates that a default application has changed.

12. The computer program product of claim 8, wherein the application configuration data indicates that a default data format has changed.

13. The computer program product of claim 8, wherein the program code is executable by the at least one processor to perform operations for:
updating an application and data format structure in accordance with the new application associated with the new data format being added.

14. The computer program product of claim 8, wherein the server data is updated and a new risk data list is generated.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
monitoring application configuration to generate application configuration data;
reconfiguring application settings based on the application configuration data and based on a risk data list, wherein the risk data list identifies one or more data files that are at risk of becoming at least one of redundant, obsolete, and trivial;
preemptively converting a data file of the data files in an existing data format to a new data format based on the reconfigured application settings;
attempting to verify the conversion by using the reconfigured application settings;
in response to determining that the conversion succeeded,
receiving a request from a new application to open the data file created in the existing data format; and
opening the data file having the new data format; and
in response to determining that the conversion failed, sending an error message to request update of server data.

16. The computer system of claim 15, wherein reconfiguring the application settings comprises creating a mapping between the new application and the existing data format.

17. The computer system of claim 15, wherein the server data comprises criteria, an application list, a data format list, an application and data format structure, an application to data format mapping structure, and a user profile.

18. The computer system of claim 15, wherein the application configuration data indicates that a default application has changed.

19. The computer system of claim 15, wherein the application configuration data indicates that a default data format has changed.

20. The computer system of claim 15, wherein the operations further comprise:
updating an application and data format structure in accordance with the new application associated with the new data format being added.
